(19) United States
(12) Patent Application Publication
(10) Pub. No.: US 2026/0214689 A1
(43) Pub. Date: Jul. 23, 2026

(54) METHOD AND APPARATUS FOR WIRELESS COMMUNICATION

(71) Applicant: QUECTEL WIRELESS SOLUTIONS CO., LTD., Shanghai (CN)

(72) Inventors: Ling LYU, Frisco, TX (US); Zheng ZHAO, Shanghai (CN)

(21) Appl. No.: 19/571,698

(22) Filed: Mar. 19, 2026

Related U.S. Application Data
(63) Continuation of application No. PCT/CN2024/099363, filed on Jun. 14, 2024.

(51) Int. Cl. H04W 72/51; H04W 72/044; H04W 72/563; H04W 84/06

(52) U.S. Cl. CPC H04W 72/51; H04W 72/044; H04W 72/563; H04W 84/06

(57) ABSTRACT

Provided are a method and apparatus for wireless communication. One example method includes: receiving, when operating in a non-terrestrial network (NTN), configuration information that indicates a plurality of priority orders respectively associated with a plurality of time-frequency resources for a half-duplex operation; transmitting or receiving a first transmission on a first resource according to a first priority order, wherein the first resource is one of the plurality of resources, the first priority order is one of the plurality of priority orders, and the first priority order corresponds to the first resource.

### CROSS-REFERENCE TO RELATED APPLICATIONS

This application is a continuation of International Application No. PCT/CN2024/099363, filed on Jun. 14, 2024, the disclosure of which is hereby incorporated by reference in its entirety.

### TECHNICAL FIELD

The present application relates to the field of communications technologies, and more specifically, to a method and an apparatus for wireless communication.

### BACKGROUND

Some communication systems (for example, non-terrestrial network (non-terrestrial network, NTN) systems) have relatively large transmission delays. In these communication systems, if a communication device communicates in half-duplex mode, an uplink transmission of the communication device may collide with a downlink reception, or may collide with another uplink transmission. Therefore, in these communication systems, how to resolve a transmission collision in half-duplex mode becomes an urgent technical problem.

### SUMMARY

The present application provides a method and an apparatus for wireless communication. Various aspects of embodiments of the present application are described below.

According to a first aspect, a method for wireless communication is provided. The method includes: transmitting or receiving, by a first device, a first transmission on a first resource according to a first priority order, where the first resource is one of a plurality of resources related to half-duplex communication, the first priority order is one of a plurality of priority orders, the plurality of priority orders are used for the plurality of resources, and the first priority order corresponds to the first resource.

According to a second aspect, a method for wireless communication is provided. The method includes: receiving or transmitting, by a second device, a first transmission on a first resource, where the first resource is one of a plurality of resources related to half-duplex communication, the first transmission is determined according to a first priority order, the first priority order is one of a plurality of priority orders, the plurality of priority orders are used for the plurality of resources, and the first priority order corresponds to the first resource.

According to a third aspect, an apparatus for wireless communication is provided. The apparatus is a first device, and the first device includes: a third transceiver unit, transmitting or receiving a first transmission on a first resource according to a first priority order, where the first resource is one of a plurality of resources related to half-duplex communication, the first priority order is one of a plurality of priority orders, the plurality of priority orders are used for the plurality of resources, and the first priority order corresponds to the first resource.

According to a fourth aspect, an apparatus for wireless communication is provided. The apparatus is a second device, and the second device includes: a fourth transceiver unit, receiving or transmitting a first transmission on a first resource, where the first resource is one of a plurality of resources related to half-duplex communication, the first transmission is determined according to a first priority order, the first priority order is one of a plurality of priority orders, the plurality of priority orders are used for the plurality of resources, and the first priority order corresponds to the first resource.

According to a fifth aspect, a communications apparatus is provided, including a memory and a processor, where the memory is configured to store a program, and the processor is configured to invoke the program from the memory to execute the method according to the first aspect or the second aspect.

According to a sixth aspect, an apparatus is provided, including a processor, invoking a program from a memory to execute the method according to the first aspect or the second aspect.

According to a seventh aspect, a chip is provided, including a processor, invoking a program from a memory to cause a device installed with the chip to execute the method according to the first aspect or the second aspect.

According to an eighth aspect, a computer-readable storage medium is provided, where the computer-readable storage medium stores a program, and the program causes a computer to execute the method according to the first aspect or the second aspect.

According to a ninth aspect, a computer program product is provided, including a program, where the program causes a computer to execute the method according to the first aspect or the second aspect.

According to a tenth aspect, a computer program is provided, where the computer program causes a computer to execute the method according to the first aspect or the second aspect.

In embodiments of the present application, a first transmission performed by a first device on a first resource is determined according to a first priority order. The first priority order is one of a plurality of priority orders corresponding to a plurality of resources used for half-duplex communication. It can be seen that in half-duplex mode, the first device may determine a transmission to be performed on different resources according to different priority orders, which is conducive to improvement of the overall transmission efficiency in a half-duplex communication scenario.

### BRIEF DESCRIPTION OF THE DRAWINGS

FIG. 1 shows a wireless communication system to which embodiments of the present application are applied.

FIG. 2 shows an NTN system to which embodiments of the present application are applied.

FIG. 3 shows another NTN system to which embodiments of the present application are applied.

FIG. 4 is a schematic diagram of a collision between a downlink transmission and an uplink transmission.

FIG. 5 is a schematic diagram of a timing advance variation of a serving cell in an NTN system.

FIG. 6 is a schematic flowchart of a method for wireless communication according to an embodiment of the present application.

FIG. 7 is a schematic flowchart of another method for wireless communication according to an embodiment of the present application.

FIG. 8 is a schematic diagram of a possible implementation of the method shown in FIG. 6.

FIG. 9 is a schematic diagram of another possible implementation of the method shown in FIG. 6.

FIG. 10 is a schematic diagram of still another possible implementation of the method shown in FIG. 6.

FIG. 11 is a schematic structural diagram of an apparatus for wireless communication according to an embodiment of the present application.

FIG. 12 is a schematic structural diagram of another apparatus for wireless communication according to an embodiment of the present application.

FIG. 13 is a schematic structural diagram of still another apparatus for wireless communication according to an embodiment of the present application.

FIG. 14 is a schematic structural diagram of yet another apparatus for wireless communication according to an embodiment of the present application.

FIG. 15 is a schematic structural diagram of a communications apparatus according to an embodiment of the present application.

### DETAILED DESCRIPTION OF THE EMBODIMENTS

The following describes the technical solutions in embodiments of the present application with reference to the accompanying drawings in embodiments of the present application. Apparently, the described embodiments are some rather than all of embodiments of the present application. For embodiments of the present application, all other embodiments obtained by a person of ordinary skill in the art without creative efforts fall within the protection scope of the present application.

Embodiments of the present application may be applied to various communications systems. For example, embodiments of the present application may be applied to a global system for mobile communication (global system of mobile communication, GSM) system, a code division multiple access (code division multiple access, CDMA) system, a wideband code division multiple access (wideband code division multiple access, WCDMA) system, a general packet radio service (general packet radio service, GPRS), a long-term evolution (long term evolution, LTE) system, an advanced long-term evolution (advanced long term evolution, LTE-A) system, a new radio (new radio, NR) system, an evolution system of an NR system, an LTE-based access to unlicensed spectrum (LTE-based access to unlicensed spectrum, LTE-U) system, an NR-based access to unlicensed spectrum (NR-based access to unlicensed spectrum, NR-U) system, a universal mobile telecommunication system (universal mobile telecommunication system, UMTS), a wireless local area network (wireless local area networks, WLAN), wireless fidelity (wireless fidelity, WiFi), and a 5th-generation (5th-generation, 5G) communications system. Embodiments of the present application may be further applied to another communications system, such as a future communications system. The future communications system may be, for example, a 6th generation (6th-generation, 6G) mobile communications system, or a satellite (satellite) communications system.

Conventional communications systems support a limited quantity of connections and are easy to implement. However, with development of communications technologies, a communications system may not only support conventional cellular communication, but may also support one or more other types of communication. For example, the communications system may support one or more of the following communication: device-to-device (device to device, D2D) communication, machine-to-machine (machine to machine, M2M) communication, machine type communication (machine type communication, MTC), enhanced machine type communication (enhanced MTC, eMTC), vehicle-to-vehicle (vehicle to vehicle, V2V) communication, vehicle-to-everything (vehicle to everything, V2X) communication, and the like. Embodiments of the present application may also be applied to a communications system that supports the foregoing communication manners.

The communication system in embodiments of the present application may be applied to a carrier aggregation (carrier aggregation, CA) scenario, a dual connectivity (dual connectivity, DC) scenario, or a standalone (standalone, SA) networking scenario.

The communication system in embodiments of the present application may be applied to an unlicensed spectrum. The unlicensed spectrum may also be considered as a shared spectrum. Alternatively, the communications system in embodiments of the present application may be applied to a licensed spectrum. The licensed spectrum may also be considered as a dedicated spectrum.

Embodiments of the present application may be applied to an NTN system. As an example, the NTN system may be a 4G-based NTN system, an NR-based NTN system, an NTN system based on an internet of things (internet of things, IoT), or an NTN system based on a narrow band internet of things (narrow band internet of things, NB-IoT).

The communications system may include one or more terminal devices. The terminal device in embodiments of the present application may also be referred to as a user equipment (user equipment, UE), an access terminal, a subscriber unit, a subscriber station, a mobile site, a mobile station (mobile station, MS), a mobile terminal (mobile Terminal, MT), a remote station, a remote terminal, a mobile device, a user terminal, a terminal, a wireless communications device, a user agent, a user apparatus, or the like.

In some embodiments, the terminal device may be a station (STATION, ST) in a WLAN. In some embodiments, the terminal device may be a cellular phone, a cordless phone, a session initiation protocol (session initiation protocol, SIP) phone, a wireless local loop (wireless local loop, WLL) station, a personal digital assistant (personal digital assistant, PDA) device, a handheld device with a wireless communication function, a computing device, or another processing device connected to a wireless modem, a vehicle-mounted device, a wearable device, a terminal device in a next-generation communication system (such as an NR system), a terminal device in a future evolved public land mobile network (public land mobile network, PLMN), or the like.

In some embodiments, the terminal device may be a device that provides a user with voice and/or data connectivity. For example, the terminal device may be a handheld device, a vehicle-mounted device, or the like that has a wireless connection function. In some specific examples, the terminal device may be a mobile phone (mobile phone), a Pad (Pad), a notebook computer, a laptop computer, a mobile internet device (mobile internet device, MID), a wearable device, a virtual reality (virtual reality, VR) device, an augmented reality (augmented reality, AR) device, a wireless terminal in industrial control (industrial control), a wireless terminal in self-driving (self driving), a wireless terminal in remote medical surgery (remote medical surgery), a wireless terminal in smart grid (smart grid), a wireless terminal in transportation safety (transportation safety), a wireless terminal in smart city (smart city), a wireless terminal in smart home (smart home), or the like.

In some embodiments, the terminal device may be deployed on land. For example, the terminal device may be deployed indoors or outdoors. In some embodiments, the terminal device may be deployed on water, for example, on a ship. In some embodiments, the terminal device may be deployed in the air, for example, on an aircraft, a balloon, and a satellite.

In addition to the terminal device, the communications system may further include one or more network devices. The network device in embodiments of the present application may be a device for communicating with the terminal device. The network device may also be referred to as an access network device or a wireless access network device. The network device may be, for example, a base station. The network device in embodiments of the present application may be a radio access network (radio access network, RAN) node (or device) that connects the terminal device to a wireless network. The base station may broadly cover various names in the following, or may be interchangeable with the following names, for example: a NodeB (NodeB), an evolved NodeB (evolved NodeB, eNB), a next generation NodeB (next generation NodeB, gNB), a relay station, an access point (access point, AP), a transmitting and receiving point (transmitting and receiving point, TRP), a transmitting point (transmitting point, TP), a master eNodeB MeNB, a secondary eNodeB SeNB, a multi-standard radio (MSR) node, a home base station, a network controller, an access node, a wireless node, a transmission node, a transceiver node, a base band unit (base band unit, BBU), a remote radio unit (remote radio unit, RRU), an active antenna unit (active antenna unit, AAU), a remote radio head (remote radio head, RRH), a central unit (central unit, CU), a distributed unit (distributed unit, DU), a positioning node, or the like. The base station may be a macro base station, a micro base station, a relay node, a donor node, or the like, or a combination thereof. Alternatively, the base station may be a communications module, a modem, or a chip disposed in the device or apparatus described above. Alternatively, the base station may be a mobile switching center, a device that functions as a base station in D2D, V2X, or M2M communication, a network-side device in a 6G network, a device that functions as a base station in a future communications system, or the like. The base station may support networks of a same access technology or different access technologies. A specific technology and a specific device form used by the network device are not limited in embodiments of the present application.

The base station may be fixed or mobile. For example, a helicopter or an unmanned aerial vehicle may be configured to serve as a mobile base station, and one or more cells may move depending on a location of the mobile base station. In other examples, a helicopter or an unmanned aerial vehicle may be configured to serve as a device in communication with another base station.

In some deployments, the network device in embodiments of the present application may be a CU or a DU, or the network device includes a CU and a DU. The gNB may further include an AAU.

As an example rather than limitation, in embodiments of the present application, the network device may have a mobile characteristic, for example, the network device may be a movable device. In some embodiments of the present application, the network device may be a satellite or a balloon station. In some embodiments of the present application, the network device may alternatively be a base station arranged on land, water, or the like.

In embodiments of the present application, the network device may provide a service for a cell. The terminal device communicates with the network device by using a transmission resource (for example, a frequency resource or a spectrum resource) used by the cell. The cell may be a cell corresponding to the network device (for example, a base station). The cell may belong to a macro station or may belong to a base station corresponding to a small cell (small cell). The small cell herein may include a metro cell (metro cell), a micro cell (micro cell), a pico cell (pico cell), a femto cell (femto cell), or the like. These small cells have characteristics of small coverage and low transmit power, and are suitable for providing a high-rate data transmission service.

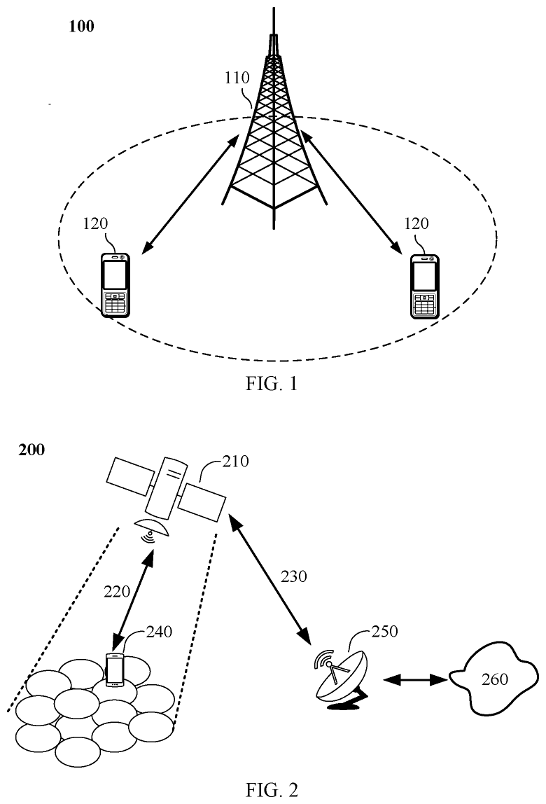

For example, FIG. 1 is a schematic architectural diagram of a communications system according to an embodiment of the present application. As shown in FIG. 1, the communications system 100 may include a network device 110, and the network device 110 may be a device that communicates with a terminal device 120 (or referred to as a communications terminal or a terminal). The network device 110 may provide communication coverage in a specific geographic area, and may communicate with a terminal device located in the coverage area.

FIG. 1 illustratively shows one network device and two terminal devices. In some embodiments of the present application, the communications system 100 may include a plurality of network devices, and another quantity of terminal devices may be included within coverage of each network device. This is not limited herein.

For example, FIG. 2 is a schematic diagram of an architecture of the NTN system mentioned above. An NTN system 200 shown in FIG. 2 uses a satellite 210 as an air platform. As shown in FIG. 2, a satellite radio access network includes a satellite 210, a service link 220, a feeder link 230, a terminal device 240, a gateway (gateway, GW) 250, and a network 260 including a base station and a core network.

The satellite 210 is a spacecraft based on a space platform. The service link 220 is a link between the satellite 210 and the terminal device 240. The feeder link 230 is a link between the gateway 250 and the satellite 210. The earth-based gateway 250 connects the satellite 210 to a base station or a core network, which specifically depends on a choice of the NTN architecture.

The NTN architecture shown in FIG. 2 is a bent-pipe transponder architecture. In this architecture, the base station is located on the earth behind the gateway 250, and the satellite 210 serves as a relay. The satellite 210 functions as a repeater for forwarding signals of the feeder link 230 to the service link 220, or forwarding signals of the service link 220 to the feeder link 230. In other words, the satellite 210 does not have a function of a base station, and communication between the terminal device 240 and the base station in the network 260 needs to be implemented by using the satellite 210.

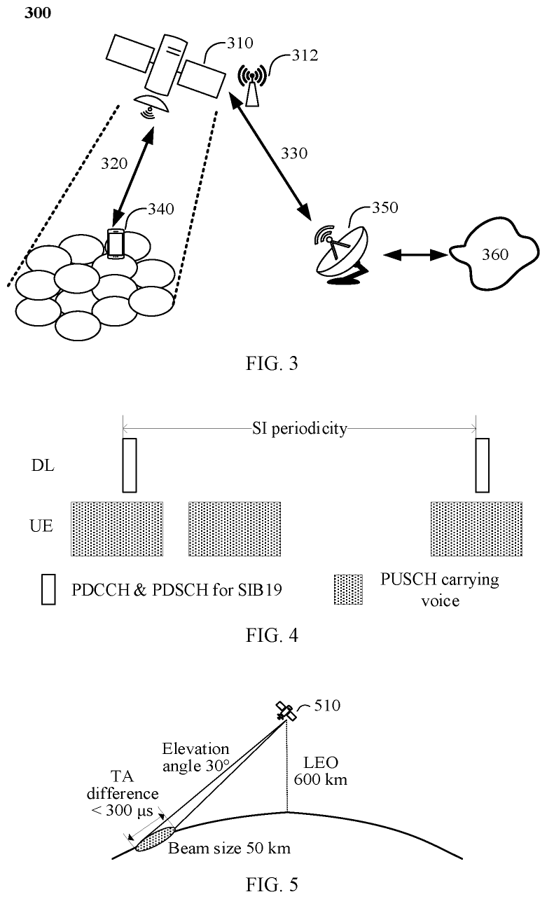

For example, FIG. 3 is a schematic diagram of another architecture of the NTN system. As shown in FIG. 3, a satellite radio access network 300 includes a satellite 310, a service link 320, a feeder link 330, a terminal device 340, a gateway 350, and a network 360. Different from that in FIG. 2, a base station 312 is provided on the satellite 310, and the network 360 behind the gateway 350 includes only a core network.

The NTN architecture shown in FIG. 3 is a regenerative transponder architecture. In this architecture, the satellite 310 carries the base station 312, and may be directly connected to an earth-based core network via a link. The satellite 310 has a function of a base station, and the terminal device 340 may directly communicate with the satellite 310. Therefore, the satellite 310 may be referred to as a network device.

The communications system with the architecture shown in FIG. 2 or FIG. 3 may include a plurality of network devices, and another quantity of terminal devices may be included within coverage of each network device. This is not limited in embodiments of the present application.

In embodiments of the present application, the communications system shown in FIG. 1 to FIG. 3 may further include another network entity such as a mobility management entity (mobility management entity, MME) or an access and mobility management function (access and mobility management function, AMF). This is not limited in embodiments of the present application.

It should be understood that a device having a communication function in a network/system in embodiments of the present application may be referred to as a communications device. The communications system 100 shown in FIG. 1 is used as an example. The communications device may include a network device 110 and a terminal device 120 that have a communication function. The network device 110 and the terminal device 120 may be specific devices described above. Details are not described herein again. The communications device may further include another device in the communications system 100, such as a network controller or a mobility management entity, which is not limited in embodiments of the present application.

For ease of understanding, some relevant technical knowledge related to embodiments of the present application is first described. The following related technologies, as optional solutions, may be randomly combined with the technical solutions of embodiments of the present application, all of which fall within the protection scope of embodiments of the present application. Embodiments of the present application include at least a part of the following content.

With development of communications technologies, communications systems (for example, 5G) will integrate market potential of satellites and terrestrial network infrastructure. For example, a 5G standard makes an NTN, including a satellite segment, to become a part of recognized 3rd generation partnership project (3rd generation partnership project, 3GPP) 5G connection infrastructure.

An NTN is a network or network segment that uses a radio frequency (radio frequency, RF) resource on a satellite platform or an unmanned aerial system (unmanned aerial system, UAS) platform. A satellite is used as an example. According to different orbital altitudes, communications satellites are classified into a low earth orbit (low earth orbit, LEO) satellite, a medium earth orbit (medium earth orbit, MEO) satellite, a geostationary earth orbit (geostationary earth orbit, GEO) satellite, a high elliptical orbit (high elliptical orbit, HEO) satellite, and the like. A LEO is an earth-centered orbit with an altitude of 2,000 km or less or at least 11.25 periods per day and an eccentricity less than 0.25. Most artificial objects in outer space are located on the LEO. The LEO satellite orbits around the earth at a high speed (mobility), but on a predictable or definite orbit.

Satellites with different orbital altitudes have different orbital periods. For example, a LEO has a typical altitude that ranges from 250 km to 1,500 km, and an orbital period that ranges from 90 minutes to 120 minutes. A MEO has a typical altitude that ranges from 5,000 km to 25,000 km, and an orbital period that ranges from 3 hours to 15 hours. A GEO has an altitude of about 35,786 km, and an orbital period of 24 hours.

As may be seen from FIG. 2 and FIG. 3 using a satellite as an example, a typical scenario in which a terminal device accesses an NTN system relates to an NTN transparent payload (payload) or an NTN regenerative payload. The bent-pipe transponder architecture shown in FIG. 2 corresponds to an NTN transparent payload, and the regenerative transponder architecture shown in FIG. 3 corresponds to an NTN regenerative payload.

In an NTN system, a terminal device located on the earth performs wireless communication via an air platform. Different from a terrestrial network (terrestrial network, TN), the NTN generally has a relatively large transmission latency. For example, because satellites are usually located over hundreds of kilometers above the surface of the earth, a propagation delay in the NTN is much longer. Specifically, the propagation delay in the NTN varies from several milliseconds to hundreds of milliseconds, depending on an altitude of a spaceborne or airborne platform and a type of a payload in the NTN.

Due to a relatively large propagation delay, it may be necessary to resolve a related problem when a technology in a terrestrial network is deployed in the NTN system. For example, in a IoT NTN of release-17 (release-17, Rel-17) or Rel-18, an NB-IoT technology is enhanced to support the NTN.

With development of IoT technology, in many IoT-like use cases in addition to NB-IoT, a RedCap (reduced capability, RedCap) terminal device can provide a service very well. That is, the RedCap device also needs to be applied to the NTN system.

RedCap is a new type of terminal capability information introduced by Rel-17. A RedCap-related terminal device may have reduced complexity and a new power saving function, thereby being more conducive to large-scale commercial popularization and application in a 5G commercial network. NR is used as an example. RedCap may reduce a capability of a device, for example, by reducing a bandwidth, a quantity of transceiver antennas, and a rate, adjusting a modulation scheme, and introducing a half-duplex mode, thereby reducing complexity of the terminal device, and achieving a series of objectives such as reducing costs and power consumption of the terminal and prolonging the service life of the terminal. Therefore, requirements of RedCap are different from those of LTE for machines (LTE for machines, LTE-M) and NB-IoT.

As can be seen from the above, RedCap supports a working mode of half duplex (half duplex, HD). In a working mode of half-duplex frequency division multiplexing (frequency division multiplexed, FDD), a communication device may transmit or receive data at different times and on different frequencies. Compared with a full-duplex FDD (FD FDD) mode, a device supporting half-duplex FDD (HD FDD) mode may not require a duplexer, thereby reducing complexity and cost. For example, a half-duplex FDD device may lower a requirement on a component in a radio frequency front end, and use a transceiver antenna switch and a low-pass filter with relatively low costs instead of a duplexer.

Because the half-duplex mode requires transmission and reception at different times and on different frequencies, when the RedCap device uses the HD FDD mode, the terminal device may need to perform downlink (downlink, DL) reception and uplink (uplink, UL) transmission at the same time. That is, a collision may occur between uplink and downlink on the terminal side.

Further, in an NTN system, there is an excessively large propagation delay between an uplink and a downlink. Due to the particularity of the NTN system, HD FDD requires a technology for uplink and downlink transmissions at different points, which may lead to more complex collision scenarios.

As an example, in NR NTN, a terminal device needs to receive a system information block (system information block, SIB) for communication. For example, the terminal device needs to read a SIB19 constantly to keep an ephemeris latest. Specifically, the terminal device can determine when to read a SIB19, based on validity of the ephemeris and a last time that a SIB19 is obtained. The SIB19 is usually carried in a system information (system information, SI) message. The message is transmitted on a downlink-shared channel (downlink-shared channel, DL-SCH). Only SIBs with a same periodicity (periodicity) can be mapped to a same SI message. Each SI message is transmitted within a periodically occurring time-domain window, where all SI messages may have SI windows of a same length. Each SI message is associated with an SI window, and SI windows of different SI messages do not overlap. That is, only a corresponding SI message is transmitted within a specific SI window. The system may transmit a corresponding SI message multiple times within an SI window. Therefore, the SIB19 may be transmitted periodically during an SI window associated with SIB19. A duration and a start time of the SI window period are known to the terminal device.

As can be seen from the above, the SIB19 is broadcast periodically, and there are many SIB19 transmissions during a validity period of the ephemeris, so that a full-duplex terminal device has a large number of opportunities to read the SIB19. However, for a half-duplex terminal device, a potential collision between a UL transmission and a SIB19 transmission may deprive the terminal device of an opportunity to read the SIB19. In addition, it is not advisable for a network device (e.g., gNB) to schedule a terminal device to avoid a UL transmission during all SIB19 transmissions, because this may result in a loss of a UL throughput for the terminal device and may also degrade some UL services or exclude the half-duplex terminal device. For example, if a UL voice packet is repeatedly transmitted 16 times every 20 milliseconds, it is almost impossible to avoid a collision between a physical uplink shared channel (physical uplink shared channel, PUSCH) carrying voice (voice) and a SIB19 transmission through scheduling by a gNB.

For ease of understanding, a collision between an uplink transmission of a terminal device (e.g., UE) and a downlink transmission of a SIB19 is illustratively described below with reference to FIG. 4. Referring to FIG. 4, the UL transmission of the terminal device is a PUSCH transmission carrying voice, and the transmission is dynamic. The downlink transmission in FIG. 4 is a physical downlink control channel (physical downlink control channel, PDCCH) or physical downlink shared channel (physical downlink control channel, PDSCH) transmission for a SIB19, which is periodically transmitted based on an SI periodicity.

As shown in FIG. 4, both of the PDCCH/PDSCH collide with the PUSCH carrying voice. According to a relevant rule, when there is a collision, the terminal device may cancel the voice transmission and/or discard the reception of the SIB19. Based on this rule, the collision between the SIB19 and the PUSCH may result in unacceptable voice quality and/or a lost opportunity to read the SIB19.

As an example, in an NTN system, the movement of a satellite causes variations in the propagation delay, making it difficult for a network device to schedule an uplink or downlink transmission. This is because the network device may not know whether a collision occurs on the terminal device side, or on which channels/signals a collision occurs on the terminal device side.

As an example, the network may evaluate a location and path loss of the terminal device, and notify the terminal device of an adjustment amount of a timing advance (timing advanced, TA) via a medium access control control element (media access control control element, MAC CE). When the TA of the terminal device is updated, the latest TA report (TA report, TAR) may also be transmitted via the MAC CE. For example, in the release 17 (release 17, Rel-17), there are two conditions that support a TAR. In a first case, the terminal device transmits a TAR during random access caused by radio resource control (radio resource control, RRC) connection establishment or RRC connection resumption, and during RRC connection re-establishment. In a second case, when a variation in the TA value is equal to or greater than a configured threshold, the terminal device reports a TA. The network device (e.g., gNB) may configure the terminal device to report a TAR based on an offset threshold. However, the network device cannot determine whether the terminal device has a transmission of uplink or downlink service data in a time instance of configuration. In addition, when the network device configures TAR reporting based on the offset threshold, a terminal device without services also needs to report a TA status from time to time, which not only causes additional power consumption of the terminal device but also occupies limited resources in the NTN uplink.

In the above example, at a time T1, within a service area of a satellite 1, the terminal device may calculate and report a TA value T_{TA} in the TA report. T_{TA} is calculated based on the following formula:

$${T}_{T A} = ( {N}_{T A} + {N}_{TA , offset} + {N}_{TA , adj}^{common} + {N}_{TA , adj}^{UE} ) {T}_{c} ,$$

where T_{c} is a basic time unit; N_{TA} is a TA value indicated in a TA command transmitted by the network device via the MAC CE, and for a transmission of a physical random access channel (physical random access channel, PRACH), N_{TA} may be defined as 0; N_{TA,offset} is a fixed offset value associated with a frequency band and/or a subcarrier spacing,

$${N}_{T A , adj}^{common}$$

is a common TA, that is, a common network control-based TA value for all terminal devices in the NTN cell, and the TA value may include any timing offset determined to be necessary by the network; N_{TA,offset} is a terminal device-specific TA (UE-specific TA), which is estimated by the terminal device itself and used to compensate for a service link delay between the terminal device and the satellite.

As an example, in the NR NTN, if the network device does not receive any TAR, or the TAR is outdated, or the granularity of TAR reporting is not fine enough, a TA mismatch (TA misalignment) may occur. For example, if the terminal device does not report a TAR, the network device cannot set some critical scheduling variables (such as K_{cell,offset} and K_{UE,offset}). For another example, when the location of the terminal device changes, an outdated TAR may cause a difference between the actual TA and the indicated TA. The difference may be a difference between a minimum TA (min TA) and a maximum TA (max TA). The difference may also occur in proportion to a difference between round-trip times (round-trip time, RTT) of the terminal device. The RTT difference may depend on the location of the terminal device in the cell. For another example, the reporting granularity of a TAR in the NTN may be 1 ms. When the difference between the minimum TA and the maximum TA in a cell is less than the reporting granularity of the TAR, a TA mismatch may occur.

For ease of understanding, taking LEO as an example, a scenario of a TA mismatch in the NTN system is illustratively described below with reference to FIG. 5. As shown in FIG. 5, the LEO is 600 km above the earth and has a beam size (beam size) of 50 km. When a target elevation angle (elevation angle) is 30 degrees, a TA difference between a shortest RTT and a longest RTT is approximately within 300 μs. The TA difference in FIG. 5 is a difference between a minimum TA and a maximum TA in a serving cell. 300 μs corresponds to approximately 4 to 5 orthogonal frequency division multiplexing (orthogonal frequency division multiplex, OFDM) symbols with a 15 kHz subcarrier spacing (subcarrier spacing, SCS). However, the reporting granularity of 1 ms is equivalent to 14 OFDM symbols with a 15 kHz SCS.

As can be seen from FIG. 5, for a 600 km LEO, when the beam size is 50 km and the target elevation angle is 30 degrees, the difference between the minimum TA and the maximum TA may be less than the TA reporting granularity (e.g., 1 ms). When the reporting granularity is 1 ms, a TA mismatch may occur within 1 ms regardless of satellite parameters. Therefore, at least 1 ms of resources may need to be reserved between DL and UL transmissions to avoid incorrect scheduling of a terminal device. Especially considering the repetition of an uplink transmission, a transmission duration in an NTN is usually longer than that in a TN. Therefore, the main cause of the TA mismatch in the LEO may be the insufficiently fine granularity of TA reporting rather than an outdated TAR.

In conclusion, when a technology that supports half-duplex such as RedCap is applied to an NTN system, it is necessary to study a possibility of supporting a half-duplex operation through NTN designation. Therefore, how to deploy a terminal device capable of half-duplex in the NTN system, how to reduce or avoid collisions that may occur in half-duplex working mode, and how to transmit when a collision occurs are all technical problems that need to be resolved urgently.

It should be noted that the above-mentioned problem of collisions in uplink and downlink transmissions of the NTN system due to RedCap's support for the half-duplex mode and a coarse TA reporting granularity is only an example. Embodiments of the present application may be applied to communication scenarios of any type of terminal device with a coarse TA reporting granularity or supporting half-duplex communication.

To resolve the foregoing problems, embodiments of the present application provide a method for wireless communication. With this method, a first transmission performed by a first device on a first resource is determined according to a first priority order. The first resource is one of a plurality of resources related to half-duplex communication, and a plurality of priority orders including the first priority order may be used for the plurality of resources. It can be seen that the plurality of resources used for half-duplex communication may select appropriate transmissions based on different priority orders, so that a transmission type on the half-duplex communication resources can be flexibly set based on communication requirements, which is conducive to reducing or avoiding transmission collisions of the first device and improving transmission efficiency.

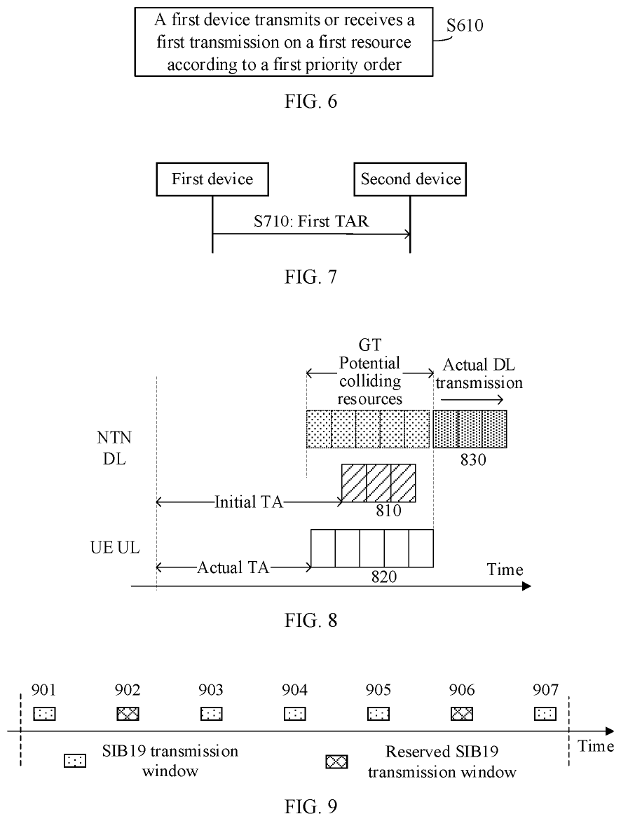

For ease of understanding, a method for wireless communication provided in embodiments of the present application is described in detail below with reference to FIG. 6.

Referring to FIG. 6, in step S610, a first device transmits or receives a first transmission on a first resource according to a first priority order. Correspondingly, a second device may receive or transmit the first transmission on the first resource.

In some embodiments, the first device may be a terminal device that performs an uplink transmission to a network device, or a terminal device that receives a downlink transmission from a network device, which is not limited herein. For example, the first device may be a UE or a relay device.

As an example, the first device may be a terminal device in an NTN system. In some embodiments, the first device may be a terminal device in an NB-IoT system. In some embodiments, the first device may be a terminal device in a network with a relatively large transmission latency.

As an example, the first device is located within a coverage area of a satellite. For example, the first device is an NTN internet-of-things terminal.

In some embodiments, the first device may be a terminal device that performs a sidelink transmission to another terminal device.

In some embodiments, the first device is a terminal device or a relay device supporting half-duplex communication. For example, the first device is a RedCap device described above. For example, the first device is any low-energy device capable of a half-duplex mode.

As an example, the first device may support both a half-duplex mode and another mode. The another mode is, for example, a full-duplex mode.

As an example, the first device may be any of a plurality of terminal devices supporting half-duplex communication in an NTN cell, which is not limited herein. For example, the first device corresponds to a serving cell of the NTN.

In some embodiments, the second device may be a network device or a network-side device in any communication system. The communication system is, for example, the NTN system. In some embodiments, the second device may include a satellite in the NTN system, and the first device may be a terminal device in a cell served by the satellite. For example, when a base station is deployed on the satellite, the first device may directly communicate with the base station on the satellite. For example, when the satellite serves as a relay, the first device may communicate, via the satellite, with a network device on the earth.

As an example, when the second device includes a satellite, the first device may be within a service area of the satellite at a current time to transmit or receive the first transmission via the satellite.

In some embodiments, the second device may be a terminal device or a relay device that communicates with the first device in a sideline communication system.

The first transmission may be a transmission of any channel, signal, or signalling, which is not limited herein. For example, the first transmission may be an uplink channel transmission such as a PUSCH transmission or PUCCH transmission, or a downlink channel transmission such as a PDCCH transmission or PDSCH transmission, or a sidelink channel transmission such as a PSSCH transmission or PSCCH transmission. For another example, the first transmission may be a transmission of an uplink reference signal, a sidelink reference signal, or a downlink reference signal. For another example, the first transmission may be a transmission of any type of signalling.

As an example, the first transmission may be any transmission performed over air interface resources.

In some embodiments, the first transmission may be any one of a plurality of transmissions. That is, the first transmission is one of the plurality of transmissions. The plurality of transmissions may include a transmission of any of the various channels, signals, or signalling described above, which is not limited herein.

In some embodiments, the plurality of transmissions may be classified according to transmission direction or transmission significance, so as to determine the first transmission.

As a possible implementation, the plurality of transmissions may include a first category of transmission and a second category of transmission other than the first category of transmission, where a priority of the first category of transmission is higher than a priority of the second category of transmission. That is, when both the first category of transmission and the second category of transmission need to be transmitted on the first resource, the first category of transmission is transmitted first.

Optionally, the first category of transmission includes one or more of the following: a downlink transmission of a SIB; a TAR and/or a TAR-triggered scheduling request (scheduling request, SR); a transmission with hybrid automatic repeat reQuest (hybrid automatic repeat reQuest, HARQ) HARQ feedback enabled/disabled; and an uplink transmission based on demodulation reference signal (demodulation reference signal, DMRS) bundling. The DL/UL transmission of the first device or the second device includes these four types of transmissions, and the priority of these four types of transmissions is higher than that of other DL/UL data transmissions.

As an example, the downlink transmission of the SIB may include a downlink transmission of a SIB19, or may be a downlink transmission of a SIB19. The downlink transmission of the SIB may also be referred to as a downlink reception of the SIB. The downlink transmission of the SIB19 may also be referred to as a downlink reception of the SIB19. The first category of transmission includes the downlink transmission of the SIB19, so that the terminal device can read latest information of an ephemeris in a timely manner.

As an example, the TAR and/or the TAR-triggered SR belongs to an uplink transmission related to the TAR. In the NR NTN, the uplink transmission related to the TAR is important information related to uplink timing. In order for the NTN network device to set an appropriate uplink timing offset (e.g., K_{cell, offset} or K_{UE, offset}), the NTN network device needs to receive TAR information in a timely manner. Therefore, the terminal device needs to execute the uplink transmission of the TAR or the SR triggered by TAR in a timely manner.

As an example, in the NTN system, some HARQ processes may have HARQ feedback enabled/disabled. Requirements for these transmissions with HARQ feedback enabled/disabled are different from those for other transmissions. Therefore, the transmission priority between DL/UL may be set according to whether HARQ feedback is enabled/disabled. For example, a transmission with HARQ feedback disabled may have a higher priority. If such transmissions have a low priority, canceling these transmissions when a collision occurs may result in a failure to receive the entire data.

As an example, the DMRS bundling may also be referred to as dedicated demodulation reference signal (dedicated demodulation reference signal, DM-RS) bundling. In the uplink transmission based on the DMRS bundling, phase continuity needs to be ensured. Therefore, after the first category of transmission includes the uplink transmission based on the DMRS bundling, phase continuity can be ensured to a limited extent by increasing the priority.

The first device transmitting or receiving the first transmission may be replaced by the first device executing the first transmission. In some embodiments, when the transmission corresponding to the first resource includes the first category of transmission, the first transmission belongs to the first category of transmission. When the transmission corresponding to the first resource does not include the first category of transmission, the first transmission may be a transmission with a higher priority among the second category of transmissions.

It should be noted that the transmission corresponding to the first resource may be a transmission desired to be executed on the first resource, or may be (pre-) configured to be executed on the first resource. When the first resource corresponds to a plurality of transmissions, it may mean that the plurality of transmissions may be executed on the first resource. Because the half-duplex mode requires transmission and reception at different times and on different frequencies, the plurality of transmissions may be subjected to a transmission collision on the first resource.

The first resource is one of a plurality of resources related to half-duplex communication. The plurality of resources related to half-duplex communication mean that the plurality of resources are used by a communication device to perform half-duplex communication in a network. In some embodiments, the plurality of resources may be dedicated resources for the half-duplex mode. In some embodiments, the plurality of resources may be resources that support both the half-duplex mode and the full-duplex mode. In some embodiments, the plurality of resources may be undefined radio resources.

For example, the first resource may be used for data transmission between the first device and the second device in a specific direction in the NTN.

In some embodiments, half-duplex communication includes an uplink transmission, a downlink reception (downlink transmission), and a sidelink transmission based on the half-duplex mode. That is, the first resource may be an uplink transmission resource, a downlink transmission resource, or a sidelink transmission resource.

In some embodiments, the plurality of resources may be determined based on a configuration of a network, or based on transmission requirements of a terminal device, or based on a TAR reported by a terminal device. The first resource determined by a TAR will be described below with respect to a plurality of triggering occasions of the TAR.

For example, the plurality of resources may be periodic transmission resources. For example, the plurality of resources may be a plurality of transmission windows for the SIB. For example, the plurality of resources may include a plurality of transmission windows for the SIB19, and the first resource may be any one or more transmission windows among the plurality of transmission windows.

For example, the plurality of resources may be reserved resources set by a network device or a terminal device for potential DL/UL collisions. For example, in an NR NTN with a TA misalignment, the setting of a guard time (guard time, GT) allows for potential resource collisions. If both a DL resource and a UL resource are present in the GT, the network side and the terminal side may consider these resources as potential DL/UL colliding resources.

For example, the plurality of resources may be a plurality of time-frequency resources of any size, which is not limited herein.

For example, the plurality of resources may include a plurality of contiguous time-frequency resources, or may include a plurality of non-contiguous time-frequency resources. The first resource may be contiguous time-frequency resources or non-contiguous time-frequency resources.

For example, the plurality of resources may be multiple different types of resources, and the first resource is one type of resource among the multiple types of resources. The multiple different types of resources may include periodically configured resources, pre-configured specific resources, resources used for specific transmissions, and the like.

For example, the first resource may be any resource among resources of a specific type. For example, when the plurality of resources include a plurality of periodically configured transmission windows and dynamically configured resources, the first resource may be some of the plurality of periodically configured transmission windows.

In some embodiments, when the first resource corresponds to a plurality of transmissions, the first device needs to select one from the plurality of transmissions to execute. The transmission selected by the first device from the plurality of transmissions corresponding to the first resource is the first transmission.

The first device transmitting or receiving the first transmission on the first resource according to the first priority order may be replaced by the first device determining the first transmission corresponding to the first resource according to the first priority order. It can be seen that the first transmission may be a transmission with the highest priority among the plurality of transmissions corresponding to the first resource. That is, the first device determines the first transmission from the plurality of transmissions in descending order of priority.

The first priority order is one of a plurality of priority orders for the plurality of resources. The plurality of priority orders may be set based on different priority principles. For example, the plurality of priority orders may further include a second priority order, and a setting principle of the second priority order is different from a setting principle of the first priority order.

When the plurality of priority orders are used for the plurality of resources, the first device or the second device may select corresponding transmissions on different resources based on different priority orders, to avoid a lower throughput of low-priority transmissions when there is only one priority order. That is, for any transmission, the priority varies on different resources. For example, for a downlink transmission of a SIB19, the priority is higher in some transmission windows and lower in other transmission windows. In a window with a higher priority, the first device may perform a downlink reception of the SIB19 to ensure timely update of ephemeris information; in a window with a lower priority, the first device may perform an uplink transmission to improve an uplink transmission throughput, thereby improving transmission efficiency.

As an example, the plurality of priority orders may correspond one-to-one to the plurality of resources. That is, the plurality of resources respectively correspond to different priority orders, so that the first device and the second device can select a transmission type according to the resources.

As an example, any of the plurality of priority orders may correspond to at least two resources among the plurality of resources. That is, at least two resources among the plurality of resources share a priority order.

As an example, a plurality of resources in a specific time period may share a priority order to ensure transmission requirements of a specific type of transmission or a specific service type in the time period.

As an example, when the plurality of resources include a plurality of transmission windows for a SIB19, the plurality of transmission windows may include two types of transmission windows corresponding to different priority orders. For example, the plurality of transmission windows may include a first transmission window and a second transmission window. A priority order corresponding to the first transmission window includes a priority of a downlink transmission of the SIB19 being the highest, and a priority order corresponding to the second transmission window includes a priority of a downlink transmission of the SIB19 being the lowest. The first transmission window may also be referred to as a reserved SIB19 window.

For example, when the first resource is the first transmission window, the priority of the downlink transmission of the SIB19 in the first priority order is the highest, and the priority of the downlink transmission of the SIB19 in the second priority order is the lowest. When the first resource is the second transmission window, the priority of the downlink transmission of the SIB19 in the first priority order is the lowest, and the priority of the downlink transmission of the SIB19 in the second priority order is the highest.

For example, a position of the downlink transmission of the SIB19 in the priority order corresponding to the first transmission window is higher than a position of the downlink transmission of the SIB19 in the priority order corresponding to the second transmission window.

As an example, in the NR NTN, for a RedCap terminal device supporting HD FDD (e), a transmission on the first resource may be determined based on one or more priority rules for NTN-specific transmissions.

In some embodiments, the first priority order may include a priority of the first category of transmission being higher than a priority of the second category of transmission, and may further include a priority order of a plurality of first category of transmissions and/or a priority order of a plurality of second category of transmissions.

As an example, for the four transmissions in the first category of transmission described above, the first priority order may include: a priority of the downlink transmission of the SIB19 being the highest, followed by a priority of the transmission with HARQ feedback enabled/disabled and a priority of the TAR and/or the TAR-triggered SR, and a priority of the uplink transmission based on DMRS bundling being the lowest.

As an example, for the four transmissions in the first category of transmission described above, the first priority order may include: a priority of the downlink transmission of the SIB19 being higher than a priority of the transmission with HARQ feedback enabled/disabled, a priority of the TAR and/or the TAR-triggered SR, and a priority of the uplink transmission based on DMRS bundling.

As an example, for the first category of transmission described above, the first priority order may include: a priority of the transmission with HARQ feedback enabled/disabled being higher than a priority of the TAR and/or the TAR-triggered SR and a priority of the uplink transmission based on DMRS bundling.

As an example, for the first category of transmission described above, the first priority order may include: a priority of the TAR and/or the TAR-triggered SR being higher than a priority of the uplink transmission based on DMRS bundling.

As an example, for the four transmissions in the first category of transmission described above, the first priority order may include: a priority of the downlink transmission of the SIB19 being the lowest, followed by a priority of the transmission with HARQ feedback enabled/disabled and a priority of the TAR and/or the TAR-triggered SR, and a priority of the uplink transmission based on DMRS bundling being the highest.

As an example, for the four transmissions in the first category of transmission described above, the first priority order may include: a priority of the transmission with HARQ feedback enabled/disabled being the highest, followed by a priority of the downlink transmission of the SIB19 and a priority of the TAR and/or the TAR-triggered SR, and a priority of the uplink transmission based on DMRS bundling being the lowest.

It should be understood that for the plurality of transmissions in the first category of transmission, the first priority order may have a plurality of other sorting methods. The plurality of sorting methods may correspond to the plurality of priority orders for determining the first transmission on a plurality of different resources.

As can be seen from FIG. 6, when a transmission collision occurs on the first resource, the first device may determine the first transmission according to the first priority order corresponding to the first resource, thereby reducing the impact of the collision on transmission efficiency. As can be seen from the above, a transmission collision in the NTN system is also related to a large granularity of TA reporting. To reduce transmission collisions, how to report a TAR has also become a technical problem that needs to be resolved.

Based on this, embodiments of the present application provide another method for wireless communication. With this method, a first device can determine whether to transmit a first TAR based on an operation service time and/or a service type. It can be seen that a trigger event of the first TAR adds service-related information of the first device, which makes the reporting granularity of the first TAR finer, thereby reducing transmission collisions. For ease of understanding, this is described in detail below with reference to FIG. 7. FIG. 7 is described from the perspective of interaction between the first device and a second device. For brevity, the terms already explained in FIG. 6 are not described again.

Referring to FIG. 7, at step S710, the first device transmits a first TAR to the second device. Correspondingly, the second device receives the first TAR transmitted by the first device. The first device may transmit the first TAR to the second device based on first information. The first information is used to trigger the first device to transmit the first TAR; that is, the first TAR is triggered based on the first information.

In some embodiments, the first information may also be referred to as TAR trigger information. The first device transmitting the first TAR based on the first information may be replaced by the first device determining whether to trigger the first TAR based on the first information.

In some embodiments, the first information may include an indication transmitted by a higher layer to trigger a TAR and a TA offset threshold configured by a higher layer. As can be seen from the above, if the first device has not previously reported a TA value to a current serving cell, or if a variation between a current estimate of the TA value and a last reported TA value is equal to or greater than the TA offset threshold (if configured), the first device is triggered to transmit the TAR. To achieve a finer TA reporting granularity, a trigger event of the first TAR may be added according to actual transmission requirements.

In some embodiments, the first information may further include service-related information of the first device. In some embodiments, alternatively, the first TAR may be triggered based on a plurality of service-related events. The plurality of service-related events are, for example, a service level, a service type, a service time limit, and an operation service time.

As an implementation, the first information may include an operation service event of the first device and/or a service type of the first device. Considering an indication or configuration from a higher layer, the first information may include one or more of the following information: an indication from a higher layer to trigger a TAR, a TA offset threshold configured by a higher layer, an operation service time of the first device, and a service type of the first device.

For example, the first TAR may be triggered based on one or more of the following information: an indication from a higher layer to trigger a TAR, a TA offset threshold configured by a higher layer, an operation service time of the first device, and a service type of the first device. That is, in response to an event related to any of the above information, the first device may transmit the first TAR. The higher layer may also be referred to as an upper layer.

As an example, the TA offset threshold is used to trigger TAR reporting, and may also be referred to as a trigger offset threshold.

In some embodiments, the first information includes the operation service time of the first device. As an example, the operation service time of the first device may indicate a time during which the first device is served, or a remaining service time of the current service. Optionally, the operation service time of the first device may be determined based on the capability and location of the first device, or may be determined based on the time during which the current cell provides the service.

As a possible implementation, when a cell corresponding to the first device is a cell in the NTN (the first device corresponds to a serving cell of the NTN), the operation service time of the first device may be determined based on the location of the first device and/or the time during which a satellite of the NTN provides the service. For example, when the location of the first device changes, the first device may leave the current cell, resulting in an excessively short operation service time. For another example, when the current satellite of the NTN cell is about to leave the cell to which the first device currently belongs, the operation service time may be less than a first threshold.

For example, when the first device receives the indication transmitted by the higher layer to trigger a TAR, and the operation service time of the first device is greater than the first threshold, the first device transmits the first TAR. That is, when the operation service time is relatively long, the first TAR is transmitted in a timely manner to reduce possible transmission collisions through a finer TAR reporting granularity.

For example, when the operation service time of the first device is equal to or less than the first threshold, the first device does not transmit the first TAR. When the remaining time of the service decreases, the first device may not transmit the first TAR, thereby reducing unnecessary power consumption. For example, the operation service time of the first device is T-UE, and after the first threshold is set to T_{target}, if T-UE is greater than T_{target}, the transmitting of the first TAR is triggered; if T-UE is less than T_{target}, the first device does not trigger the transmitting of the first TAR, so as to avoid unnecessary power consumption of the first device.

As a possible implementation, the first threshold may be configured by the higher layer or determined by the first device itself.

As a possible implementation, in the NTN system, the first threshold may be determined based on a service time of a satellite. The satellite currently provides service for the cell to which the first device belongs. The service time of the satellite may be the remaining service time of the current satellite in the serving cell. For example, the first threshold T_{target} may be 10%×T-service, where T-service is the service time of the NTN satellite. For example, when the operation service time of the first device is within T-service, the transmitting of the first TAR is triggered; when the operation service time of the first device is beyond T-service, the transmitting of the first TAR is not triggered.

In some embodiments, the first information includes the service type of the first device. The service type of the first device may refer to a type of resources required for the service of the first device, or may refer to an application scenario of the service, or may refer to a service level, which is not limited herein.

As an example, the service type of the first device may be used to set a timer related to TAR triggering. The addition of the method for triggering a TAR via the timer based on the service type allows the reporting granularity of the TAR to be related to the service type. That is, the first device may trigger the transmitting of the TAR based on the timer corresponding to the service type.

For example, the service type of the first device is used for the first device to set a first timer related to the TA offset threshold. That is, the first device may set the first timer related to the TA offset threshold based on the service type. For different service types, different durations may be set for the first timer. It can be seen that the setting of offsetThresholdTA (TA offset threshold) is not only related to the location information, but also to the service type. For different services, offsetThresholdTA has different values. For example, the higher the service level of the first device, the smaller the offsetThresholdTA value may be set to, thereby achieving a smaller trigger offset threshold.

Optionally, the first device may transmit the first TAR based on the indication from an upper layer to trigger a TAR.

Optionally, when offsetThresholdTA is configured by the upper layer, if the variation in the TA value is equal to or greater than offsetThresholdTA, the first device transmits the first TAR.

Optionally, the first device may trigger the transmitting of the first TAR based on the operation service time and the indication from the higher layer to avoid or reduce collisions. After the introduction of triggering based on the operation service time, the first device may check its own service time after receiving the indication from the upper layer to trigger a TAR, so as to determine whether to transmit the first TAR according to the relationship between the service time and the threshold.

Optionally, the first device may determine whether to transmit the first TAR based on the location information and the service type.

In some embodiments, to achieve more accurate TA reporting, the related TA reporting mechanism may be directly enhanced. As an implementation, the first device may use a reporting MAC CE of the same size as a TAR MAC CE (2 octets) to provide a finer reporting granularity. In the related technology, a TA value of the first TAR transmitted by using the 2 octets of the MAC CE for the current time is T_{TA}, and the TA value may be referred to as a first TA value in the first TAR. As can be seen from the calculation formula for T_{TA} described above, the first TA value in the first TAR may be determined based on a TA value (N_{TA}) in a TA command, a first offset value (N_{TA,offset}), a common

$$TA ( {N}_{T A , adj}^{common} ) ,$$

and a dedicated TA value

$$( {N}_{TA , adj}^{UE} )$$

of the first device.

It should be understood that when the TAR MAC CE corresponds to 2 octets, the 2 octets may be a first byte segment corresponding to the first TAR. When the TAR MAC CE corresponds to a byte segment of another length, the byte segment of another length is the first byte segment corresponding to the first TAR.

As an embodiment, to provide a finer reporting granularity, the first device may use the MAC CE to report only the dedicated TA value being estimated by the first device, that is, the component

$$( {N}_{TA , adj}^{UE} )$$

specific to the first device in T_{TA}. That is, when the first TAR is triggered, the first device may transmit only the dedicated TA value of the first device by using the first byte segment.

As an embodiment, to provide a finer reporting granularity, the first device may use the MAC CE to report only a change value, i.e., ΔT_{TA}, of the current T_{TA} relative to the last reported TA value. That is, when the first TAR is triggered, the first device may transmit a difference between the first TA value and a second TA value by using the first byte segment, where the second TA value is a TA value in a second TAR transmitted by the first device last time. It should be understood that the last transmission may be a previous transmission adjacent to a transmission occasion for the first TAR, or may be an initial transmission.

In the above-described embodiments, the dedicated TA value or ΔT_{TA} can be used as an alternative to reporting the entire T_{TA} value to a gNB within a specific period of time. This is because the calculated parameter for

$${N}_{T A , adj}^{common}$$

is still valid and known on both the UE and gNB sides within the specific period of time. Therefore, the 2 octets of the enhanced reporting MAC CE can be fully used to transmit the variables in the entire TA value (the first TA value).

As an embodiment, the first byte segment corresponding to the first TAR may be divided into at least two second byte segments. One of the at least two second byte segments is used to transmit the dedicated TA value of the first device, or the difference (ΔT_{TA}) between the first TA value and the second TA value in the first TAR. For example, the first device may use a nibble to report the dedicated TA value of the first device or ΔT_{TA}. It can be seen that 2 octets can facilitate the first device to report TA-related parameters more frequently.

In some embodiments, the second device may configure the first resource based on the first TAR. When the TA value in the first TAR is relatively accurate, a probability of a transmission collision occurring on the first resource is reduced. That is, in some scenarios, the first resource may be determined based on the first TAR reported by the first device. As an example, the second device may configure the first resource in FIG. 6 based on the first TAR.

In some embodiments, a network device may configure, based on the first TAR, resources for a plurality of downlink transmissions for communicating with the first device. The plurality of downlink transmissions may include a PDCCH or a PDSCH, which is not limited herein.

In some embodiments, the network device may configure resources for a plurality of uplink transmissions for the first device based on the first TAR. The plurality of uplink transmissions may include an SR, a transmission with HARQ feedback enabled/disabled, and an uplink transmission based on DMRS bundling described above, and may also include other data transmissions. The first resource is a resource used for any of the plurality of uplink transmissions, which is not limited herein.

As an example, when the first resource is a reserved resource configured based on a GT, the TA value of the first TAR is used to determine the reserved resource.

As can be seen from FIG. 7, the embodiment of the present application adds a plurality of triggering occasions for the first TAR and proposes an enhanced reporting method to achieve a finer reporting granularity. As can be seen from the above, in the NTN system, the long distance between a satellite and a terrestrial communication device causes a large transmission latency. For half-duplex communication in the NTN system, even if the reporting granularity of the first TAR is finer, a collision between uplink and downlink transmissions may still occur in the first device. When a transmission collision occurs, transmission may be performed according to the method shown in FIG. 6.

In embodiments of the present application, the newly added triggering occasions and enhanced reporting method of the first TAR can be used alone or in combination with the method for determining the first transmission on the first resource based on the first priority order. For example, after determining the first resource based on the first TAR, the first device may transmit or receive the first transmission on the first resource according to the first priority order described above.

As can be seen from the above, the first resource may be a periodically configured resource or a reserved resource. When the first resource is a reserved resource configured by using a method based on a guard time, the first resource may be related to the first TAR. Compared with the related technology, the first TAR can be triggered based on more events to achieve a finer TA reporting granularity. The introduction of a finer TA reporting granularity and a smaller trigger offset threshold can reduce a ratio of unavailable resources.

In some embodiments, when the reporting granularity of the TA is finer, the network device (the second device) can receive an actual TA of the first device in a more timely manner, thereby performing resource configuration for uplink and downlink transmissions more accurately. The resource configuration may include configuring a plurality of resources, including the first resource, for the first device. This shows that a finer TA reporting granularity can effectively reduce uplink and downlink transmission collisions.

In some embodiments, a smaller trigger offset threshold means that the TAR is transmitted even when a difference between the actual TA and an initial TA of the first device is small, which can also facilitate the second device to update the TA value in a timely manner.

Based on FIG. 6 and FIG. 7, it can be seen that the first resource may be related to the first TAR transmitted by the first device, or may be a downlink resource configured by the network device itself, which is not limited herein. For ease of understanding, a plurality of types of first resources are described below with reference to FIG. 8 to FIG. 10.

In some embodiments, the first resource may include a reserved resource determined based on a guard time (GT). As can be seen from the above, resources corresponding to the guard time may be referred to as potential DL/UL colliding resources, that is, potential colliding resources. As an example, a value of the GT may be set to be large enough to eliminate a synchronization error between the network device and the terminal device caused by a TA misalignment.

In some embodiments, the terminal device and the network device know that a resource collision will occur during a time period corresponding to the GT, and therefore the guard time may be configured between colliding transmissions to avoid the collision. For example, the GT is configured between a DL transmission and a UL transmission.

In some embodiments, the guard time may be determined based on the first TA value in the first TAR. The first TA value is a UL TA transmitted by the terminal device. The network device and the terminal device may determine GT-based DL/UL colliding resources under the assumption of the same UL TA. For example, the network device and the terminal device may assume the common TA or the TA value in the latest TA report as the UL TA, and then determine potential DL/UL colliding resources based on the GT. For example, under the assumption of a given UL TA, there may be DL/UL resources in the GT. That is, the first resource corresponding to the GT may be used for a DL/UL transmission.

As an example, whether the DL transmission and the UL transmission overlap in the time domain is determined based on the actual TA known to both the network device and the first device, where the actual TA is determined by the last reported TAR of the first device. That is, the guard time is determined based on the current first TAR rather than the initial TA of the first device, so that a TA mismatch problem can be avoided. For example, the network device and the first device may first determine the guard time based on a gap (GAP) between the latest reported actual

$$TA ( {T}_{TA}^{Report} )$$

and the initial TA. The gap may be a gap between the actual TA and the initial TA, or a gap (difference) Δ_{TA} between the current TA and the previous TA. During the guard time, UL and DL transmission resources will not collide.

In some embodiments, a start time of the guard time is

$${T}_{TA}^{Report} - {Δ}_{TA} ,$$

and an end time of the guard time is

$${T}_{TA}^{Report} + {Δ}_{TA} , where {T}_{TA}^{Report}$$

represents a current TA value of the first device, and Δ_{TA} represents a difference between the current TA value and a previous TA value. It should be understood that the current TA value of the first device may be an actual parameter closest to the current situation.

Optionally, the current TA value of the first device may be the first TA value in the first TAR, or may be a dedicated TA value of the first device for determining the first TA value. For example, Δ_{TA} may be ΔT_{TA} described above, or may be a difference between two adjacent dedicated TA values.

As an example, the first resource may include a resource corresponding to the guard time. When the guard time corresponds to a plurality of transmissions, the first device may determine the first transmission from the plurality of transmissions based on the first priority order. A transmission other than the first transmission among the plurality of transmissions are performed on a resource after the guard time. The plurality of transmissions are as described above and will not be repeated herein.

As an embodiment, when the plurality of transmissions include a DL transmission and a UL transmission, if the first priority order indicates that a priority of the DL transmission is higher than a priority of the UL transmission, the first transmission is the DL transmission; and if the first priority order indicates that a priority of the UL transmission is higher than a priority of the DL transmission, the first transmission is the UL transmission.

As a sub-embodiment of the above-described embodiment, when the first transmission is the DL transmission, the first device transmits the UL transmission on a resource after the guard time; and when the first transmission is the UL transmission, the first device receives the DL transmission on the resource after the guard time.

For ease of understanding, this is illustratively described below with reference to FIG. 8. In FIG. 8, the first device is a UE, and the second device is a network device in the NTN. Referring to FIG. 8, in the NTN, the second device configures 3 time units of DL resources 810 based on an initial TA to transmit a DL transmission. The first device configures 5 time units of UL resources 820 based on an actual TA. Potential GT-based colliding resources are configured based on the actual TA, thereby avoiding a collision caused by a difference between the actual TA and the initial TA.

A priority order in the GT in FIG. 8 is a priority of the UL transmission being higher than a priority of the DL transmission. As shown in FIG. 8, the first transmission is the UL transmission occupying the resources 820. The actual DL transmission 830 is performed on a resource after the guard time.

Further, if the TA is not updated in a timely manner, the actual TA may be different from the initial TA by a specific gap, and then the uplink and downlink colliding resources need to be based on the actual TA. Setting the GT on the colliding resources can allow the DL to avoid colliding uplink resources based on the first priority order, so that the DL can be properly transmitted and received by the first device.

In some embodiments, the guard time may be determined based on a change value of a distance between the first device and the network device. When the network device is a satellite in the NTN, the faster the first device moves, the larger the Doppler frequency shift is, and the larger a deviation from TA estimation is. Therefore, a value of the GT may be set to a range: 1-14 slots, for example.

In some embodiments, the distance between the first device and the satellite may be represented by an elevation angle. Assuming that a connecting line between the terminal device and the satellite is a first connecting line, and a connecting line between the terminal device and a projection of the satellite on the earth is a second connecting line, the elevation angle may be an included angle between the first connecting line and the second connecting line. Assuming that an altitude of the satellite is h, a horizontal distance from the first device to the projection of the satellite on the earth is d, the elevation angle θ of the first device is:

$$θ = arctan ( \frac{h}{d} ) .$$

As an example, the elevation angle may range from 0° to 90°. The guard time may be determined based on the elevation angle between the first device and the satellite in the NTN. A larger elevation angle indicates a closer distance between the first device and the satellite, and the guard time may be relatively short. Conversely, a smaller elevation angle indicates a farther distance between the first device and the satellite, and the guard time may be relatively long.

As an example, the guard time may be determined based on a change value of the elevation angle between the first device and the satellite in the NTN within a first time period. The first time period may be configured by the network device or the higher layer, which is not limited herein. That is, the value of the GT may be determined according to the change in the elevation angle between the first device and the satellite.

As an example, the change value of the elevation angle within the first time period belongs to a plurality of value ranges. The plurality of value ranges include a first value range and a second value range, where the first value range corresponds to a first guard time, and the second value range corresponds to a second guard time.

In the above-described example, when an upper limit value of the first value range is less than an upper limit value of the second value range, a length of the first guard time is less than a length of the second guard time. Alternatively, when a lower limit value of the first value range is less than a lower limit value of the second value range, a length of the first guard time is less than a length of the second guard time.

In the above-described example, when an upper limit value of the first value range is greater than an upper limit value of the second value range, a length of the first guard time is greater than a length of the second guard time. Alternatively, when a lower limit value of the first value range is greater than a lower limit value of the second value range, a length of the first guard time is greater than a length of the second guard time.

In the above-described example, when a lower limit value of the first value range is greater than or equal to an upper limit value of the second value range, a length of the first guard time is greater than a length of the second guard time. That is, the larger the lower limit value of the value range, the longer the guard time, as shown in Table 1. For example, Table 1 shows an implementation of determining the value of the GT based on a change (Δθ) of the θ value.

TABLE 1

| Δθ(°) | GT | |
|---|---|---|
| ≤10 | 1 | slot |
| 10 < Δθ ≤ 20 | 2 | slots |
| 20 < Δθ ≤ 30 | 3 | slots |
| 30 < Δθ ≤ 40 | 4 | slots |
| 40 < Δθ ≤ 50 | 5 | slots |
| 50 < Δθ ≤ 60 | 6 | slots |
| 60 < Δθ ≤ 70 | 7 | slots |

| | |
|---|---|
| . . . | . . . |

As an example, the GT may be set to a fixed value. For example, the fixed value is set based on a maximum change value (Δθₘₐₓ) of the θ value to ensure that the UL and DL transmissions do not collide. For example, Δθₘₐₓ may be 90°.

As an example, when the actual TA is not aligned and the actual colliding resources are greater than the GT, exception handling is required. For example, when the GT is no longer valid, the first device may execute TA reporting to the network device to reconfigure the value of the GT.

As can be seen from the above, the first resource may be some of the plurality of transmission windows for a SIB19, that is, the first transmission windows. To ensure a time for the first device to read the SIB19, a subset (reserved SIB19 transmission windows) of the SIB19 transmission windows may be configured as shown in FIG. 9. These reserved SIB19 transmission windows are the first transmission windows. As described above, during the first transmission window, the first device may prioritize the reception of the PDCCH and PDSCH related to the SIB19. That is, a downlink transmission of the SIB19 has a higher priority.

As an example, the first transmission window with the highest priority for the downlink transmission of the SIB19 may be configured to be within a specific time.

As an example, the plurality of transmission windows for the SIB19 are divided into one or more transmission windows belonging to the first transmission window and one or more transmission windows belonging to the second transmission window. In the first transmission window, the SIB19 downlink transmission has a higher priority than a UL transmission. That is, the first device needs to wait for the transmission of the SIB19 in the reserved window, prioritize the reception of the SIB19, and cannot perform a transmission of UL data, so as to effectively avoid a collision. In the second transmission window, the first device may directly transmit UL data.

As an example, the plurality of SIB19 reserved resources included in the first resource may be transmitted via a broadcast message.

As an example, the network device may configure two first transmission windows every 1,024 subframes. As a response, the first device supporting half-duplex communication will attempt to read the SIB19 during one of the two transmission windows.

For ease of understanding, this is illustratively described below with reference to an implementation of FIG. 9. Seven SIB19 transmission windows in FIG. 9 are a window 901 to a window 907, respectively. The window 902 and the window 906 are reserved (reserved) SIB19 transmission windows (first transmission windows), and the other windows are second transmission windows. In the windows 902 and 906, the first device mainly reads the SIB19, in which case the downlink transmission of the SIB19 has the highest priority. In the windows 901, 903 to 905, and 907, the second device still transmits the SIB19, but the first device does not read it but directly performs an uplink transmission, in which case the downlink transmission of the SIB19 has the lowest priority.

In some embodiments, for the NR NTN, due to an unknown UE TA, a UL retention duration is unknown to the NTN network device. However, the NTN network device knows a minimum TA (TAₘᵢₙ) and a maximum TA (TAₘₐₓ) of a cell, and therefore, the network device can use this TA range to determine a duration of a corresponding SI of the SIB19.

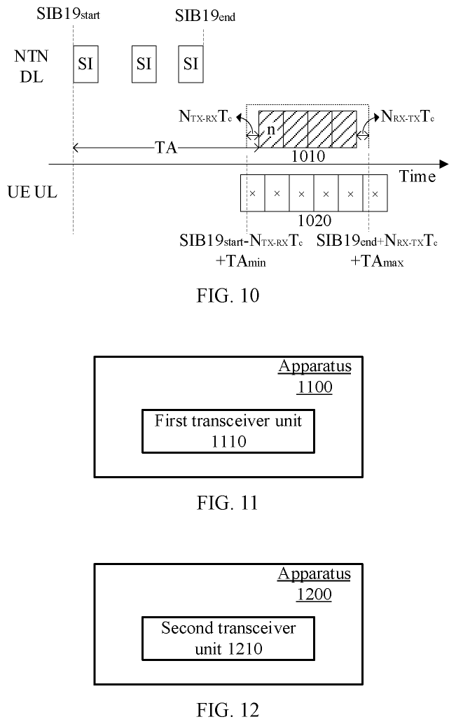

This is illustratively described below with reference to FIG. 10. In FIG. 10, the UE side is the first device side, and the NTN side is the second device side. N_{TX-RX} is a time when the first device performs transmit-to-receive switching, N_{RX-TX} is a time when the first device performs receive-to-transmit switching. T_{C} represents a minimum sampling time periodicity in the system. The switching time is not included in the collision time.

As shown in FIG. 10, the second device transmits the SIB19 in a plurality of downlink time units (e.g., symbols) corresponding to an SI window, where a start point of the plurality of downlink time units is SIB19ₛₜₐᵣₜ, and an end point is SIB19_{end}. During this time period, there may be no collision with the uplink. An SI subset of the SIB19 can be transmitted during this time period.

A TA in FIG. 10 belongs to a TA range of the cell, that is, [TAₘᵢₙ, TAₘₐₓ]. Based on this TA range, six uplink time units 1020 that overlap with a duration starting from SIB19ₛₜₐᵣₜ−N_{TX-RX}T_{C}+TAₘᵢₙ will collide with the downlink reception of the SIB19. Therefore, for all first devices in the NTN cell, uplink time units outside the duration from SIB19ₛₜₐᵣₜ−N_{TX-RX}T_{C}+TAₘᵢₙ to SIB19_{end}−N_{RX-TX}T_{C}+TAₘₐₓ will not collide with the downlink reception of the SIB19. Therefore, within the duration determined based on the TA range in FIG. 10, the downlink reception of the SIB19 may have a higher priority. That is, the first device does not perform an uplink transmission within the duration, and thus can correctly receive the SIB19.

The method embodiments of the present application are described in detail above with reference to FIG. 1 to FIG. 10. The apparatus embodiments of the present application are described in detail below with reference to FIG. 11 to FIG. 15. It should be understood that the description of the apparatus embodiments corresponds to the description of the method embodiments, and therefore, for parts that are not described in detail, reference may be made to the foregoing method embodiments.

FIG. 11 is a schematic block diagram of an apparatus for wireless communication according to an embodiment of the present application. The apparatus 1100 may be any one of the first devices described above. The apparatus 1100 shown in FIG. 11 includes a first transceiver unit 1110.

The first transceiver unit 1110 may be configured to transmit a first TAR based on first information, where the first information includes an operation service time of the first device and/or a service type of the first device.

Optionally, the first information further includes one or more of the following information: an indication transmitted by a higher layer to trigger a TAR and a TA offset threshold configured by a higher layer.

Optionally, the first transceiver unit 1110 is further configured to transmit a first TAR when the first device receives the indication to trigger a TAR and the operation service time of the first device is greater than a first threshold; or skip transmitting the first TAR when the operation service time of the first device is equal to or less than the first threshold.

Optionally, the first device corresponds to a serving cell of an NTN, and the first threshold is determined based on a service time of a satellite corresponding to the serving cell.

Optionally, the first device corresponds to a serving cell of an NTN, and the operation service time of the first device is determined based on a location of the first device and/or a service time of a satellite corresponding to the serving cell.

Optionally, the service type of the first device is related to a TA offset threshold, and the apparatus 1100 further includes a processing unit that may be configured to set a first timer related to the TA offset threshold based on the service type.

Optionally, a first TA value in the first TAR is determined based on a TA value in a TA command, a first offset value, a common TA, and a dedicated TA value of the first device. The first transceiver unit 1110 is further configured to transmit the dedicated TA value of the first device or a difference between the first TA value and a second TA value, by using a first byte segment corresponding to the first TAR when the first TAR is triggered, where the second TA value is a TA value in a second TAR transmitted by the first device last time.

Optionally, the first byte segment corresponding to the first TAR is divided into at least two second byte segments, and one of the at least two second byte segments is used to transmit a dedicated TA value of the first device or the difference between a first TA value and a second TA value in the first TAR, where the second TA value is a TA value in a second TAR transmitted by the first device last time.

Optionally, the first TAR is used to determine a first resource, and the first transceiver unit 1110 is further configured to transmit or receive a first transmission on the first resource according to a first priority order, where the first resource is one of a plurality of resources related to half-duplex communication, the first priority order is one of a plurality of priority orders, the plurality of priority orders are used for the plurality of resources, and the first priority order corresponds to the first resource.

Optionally, the first transceiver unit 1110 in the apparatus 1100 may be a transceiver 1530, and the apparatus 1100 may further include a processor 1510 and a memory 1520, as specifically shown in FIG. 15.

FIG. 12 is a schematic block diagram of another apparatus for wireless communication according to an embodiment of the present application. The apparatus 1200 may be any second device described above. The apparatus 1200 shown in FIG. 12 includes a second transceiver unit 1210.

The second transceiver unit 1210 may be configured to receive a first TAR transmitted by a first device, where the first TAR is triggered based on first information, and the first information includes an operation service time of the first device and/or a service type of the first device.

Optionally, the first information further includes one or more of the following information: an indication transmitted by a higher layer to trigger a TAR and a TA offset threshold configured by a higher layer.

Optionally, when the first device receives the indication to trigger a TAR and the operation service time of the first device is greater than a first threshold, the first TAR is triggered; or when the operation service time of the first device is equal to or less than the first threshold, the first TAR is not triggered.

Optionally, the second device includes a satellite in an NTN, and the first threshold is determined based on a service time of the satellite.

Optionally, the second device includes a satellite in an NTN, and the operation service time of the first device is determined based on a location of the first device and/or a service time of the satellite.

Optionally, the service type of the first device is related to a TA offset threshold, the TA offset threshold is related to a first timer, and the first timer is set based on the service type.

Optionally, a first TA value in the first TAR is determined based on a TA value in a TA command, a first offset value, a common TA, and a dedicated TA value of the first device. The second transceiver unit 1210 is further configured to receive the dedicated TA value of the first device or a difference between the first TA value and a second TA value, by using a first byte segment corresponding to the first TAR when the first TAR is triggered, where the second TA value is a TA value in a second TAR transmitted by the first device last time.

Optionally, the first byte segment corresponding to the first TAR is divided into at least two second byte segments, and one of the at least two second byte segments is used to transmit a dedicated TA value of the first device or the difference between a first TA value and a second TA value in the first TAR, where the second TA value is a TA value in a second TAR transmitted by the first device last time.

Optionally, the first TAR is used to determine a first resource, and the second transceiver unit 1210 is further configured to receive or transmit a first transmission on the first resource, where the first resource is one of a plurality of resources related to half-duplex communication, the first transmission is determined according to a first priority order, the first priority order is one of a plurality of priority orders, the plurality of priority orders are used for the plurality of resources, and the first priority order corresponds to the first resource.

Optionally, the second transceiver unit 1210 in the apparatus 1200 may be a transceiver 1530, and the apparatus 1200 may further include a processor 1510 and a memory 1520, as specifically shown in FIG. 15.

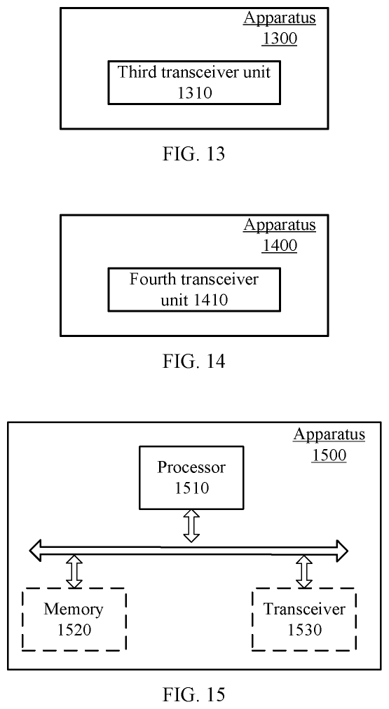

FIG. 13 is a schematic block diagram of an apparatus for wireless communication according to an embodiment of the present application. The apparatus 1300 may be any one of the first devices described above. The apparatus 1300 shown in FIG. 13 includes a third transceiver unit 1310.

The third transceiver unit 1310 may be configured to transmit or receive a first transmission on a first resource according to a first priority order, where the first resource is one of a plurality of resources related to half-duplex communication, the first priority order is one of a plurality of priority orders, the plurality of priority orders are used for the plurality of resources, and the first priority order corresponds to the first resource.

Optionally, the first transmission is one of a plurality of transmissions, the plurality of transmissions include a first category of transmission and a second category of transmission other than the first category of transmission, the first priority order includes a priority of the first category of transmission being higher than a priority of the second category of transmission, and the first category of transmission includes one or more of the following: a downlink transmission of a SIB; a TAR and/or a TAR-triggered SR; a transmission with HARQ feedback enabled/disabled; or an uplink transmission based on DMRS bundling.

Optionally, the first category of transmission further includes a downlink transmission of a SIB19, and the first priority order includes a priority of the downlink transmission of the SIB19 being higher than a priority of the transmission with HARQ feedback enabled/disabled, a priority of the TAR and/or the TAR-triggered SR, and a priority of the uplink transmission based on DMRS bundling.

Optionally, the first priority order includes a priority of the transmission with HARQ feedback enabled/disabled being higher than a priority of the TAR and/or the TAR-triggered SR and a priority of the uplink transmission based on DMRS bundling.

Optionally, the first priority order includes a priority of the TAR and/or the TAR-triggered SR being higher than a priority of the uplink transmission based on DMRS bundling.

Optionally, the first resource is related to a first TAR sent by a first device, where the first TAR is triggered based on one or more of the following information: an indication sent by a higher layer to trigger a TAR; a TA offset threshold configured by a higher layer; an operation service time of the first device; and a service type of the first device.

Optionally, the first resource includes a resource corresponding to a guard time, and when the guard time corresponds to a plurality of transmissions, the apparatus 1300 further includes a determining unit that be configured to determine the first transmission from the plurality of transmissions based on the first priority order, where a transmission other than the first transmission among the plurality of transmissions are performed on a resource after the guard time.

Optionally, the guard time is determined based on an elevation angle between a first device and a satellite in an NTN and/or a change value of the elevation angle within a first time period.

Optionally, the change value of the elevation angle within the first time period belongs to a plurality of value ranges, the plurality of value ranges include a first value range and a second value range, the first value range corresponds to a first guard time, and the second value range corresponds to a second guard time, where when a lower limit value of the first value range is greater than or equal to an upper limit value of the second value range, a length of the first guard time is greater than a length of the second guard time.

Optionally, a start time of the guard time is

$${T}_{TA}^{Report} - {Δ}_{TA} ,$$

and an end time of the guard time is

$${T}_{TA}^{Report} + {Δ}_{TA} , where {T}_{TA}^{Report}$$

represents a current TA value of a first device, and Δ_{TA} represents a difference between the current TA value and a previous TA value.

Optionally, the plurality of resources include a plurality of transmission windows for a SIB19, and the plurality of transmission windows include a first transmission window and a second transmission window, where a priority order corresponding to the first transmission window includes a priority of a downlink transmission of the SIB19 being the highest, and a priority order corresponding to the second transmission window includes a priority of a downlink transmission of the SIB19 being the lowest.

Optionally, the third transceiver unit 1310 in the apparatus 1300 may be a transceiver 1530, and the apparatus 1300 may further include a processor 1510 and a memory 1520, as specifically shown in FIG. 15.

FIG. 14 is a schematic block diagram of another apparatus for wireless communication according to an embodiment of the present application. The apparatus 1400 may be any second device described above. The apparatus 1400 shown in FIG. 14 includes a fourth transceiver unit 1410.

The fourth transceiver unit 1410 may be configured to receive or transmit a first transmission on a first resource, where the first resource is one of a plurality of resources related to half-duplex communication, the first transmission is determined according to a first priority order, the first priority order is one of a plurality of priority orders, the plurality of priority orders are used for the plurality of resources, and the first priority order corresponds to the first resource.

Optionally, the first transmission is one of a plurality of transmissions, the plurality of transmissions include a first category of transmission and a second category of transmission other than the first category of transmission, the first priority order includes a priority of the first category of transmission being higher than a priority of the second category of transmission, and the first category of transmission includes one or more of the following: a downlink reception of a SIB; a TAR and/or a TAR-triggered SR; a transmission with HARQ feedback enabled/disabled; or an uplink transmission based on DMRS bundling.

Optionally, the first category of transmission further includes a downlink reception of a SIB19, and the first priority order includes a priority of the downlink reception of the SIB19 being higher than a priority of the transmission with HARQ feedback enabled/disabled, a priority of the TAR and/or the TAR-triggered SR, and a priority of the uplink transmission based on DMRS bundling.

Optionally, the first priority order includes a priority of the transmission with HARQ feedback enabled/disabled being higher than a priority of the TAR and/or the TAR-triggered SR and a priority of the uplink transmission based on DMRS bundling.

Optionally, the first priority order includes a priority of the TAR and/or the TAR-triggered SR being higher than a priority of the uplink transmission based on DMRS bundling.

Optionally, the first resource is related to a first TAR sent by a first device, where the first TAR is triggered based on one or more of the following information: an indication sent by a higher layer to trigger a TAR; a TA offset threshold configured by a higher layer; an operation service time of the first device; and a service type of the first device.

Optionally, the first resource includes a resource corresponding to a guard time, and when the guard time corresponds to a plurality of transmissions, the first priority order is used to determine the first transmission from the plurality of transmissions, where a transmission other than the first transmission among the plurality of transmissions are performed on a resource after the guard time.

Optionally, the guard time is determined based on an elevation angle between a first device and a satellite in an NTN and/or a change value of the elevation angle within a first time period.

Optionally, the change value of the elevation angle within the first time period belongs to a plurality of value ranges, the plurality of value ranges include a first value range and a second value range, the first value range corresponds to a first guard time, and the second value range corresponds to a second guard time, where when a lower limit value of the first value range is greater than or equal to an upper limit value of the second value range, a length of the first guard time is greater than a length of the second guard time.

Optionally, a start time of the guard time is

$${T}_{TA}^{Report} - {Δ}_{TA} ,$$

and an end time of the guard time is

$${T}_{TA}^{Report} + {Δ}_{T A} , where {T}_{T A}^{Report}$$

represents a current TA value of a first device, and Δ_{TA} represents a difference between the current TA value and a previous TA value.

Optionally, the plurality of resources include a plurality of transmission windows for a SIB19, and the plurality of transmission windows include a first transmission window and a second transmission window, where a priority order corresponding to the first transmission window includes a priority of a downlink reception of the SIB19 being the highest, and a priority order corresponding to the second transmission window includes a priority of a downlink reception of the SIB19 being the lowest.

Optionally, the fourth transceiver unit 1410 in the apparatus 1400 may be a transceiver 1530, and the apparatus 1400 may further include a processor 1510 and a memory 1520, as specifically shown in FIG. 15.

FIG. 15 is a schematic structural diagram of a communication apparatus according to an embodiment of the present application. Dashed lines in FIG. 15 indicate that a unit or module is optional. The apparatus 1500 may be configured to implement the methods described in the foregoing method embodiments. The apparatus 1500 may be a chip, a terminal device, or a network device.

The apparatus 1500 may include one or more processors 1510. The processor 1510 may support the apparatus 1500 in implementing the methods described in the foregoing method embodiments. The processor 1510 may be a general-purpose processor or a dedicated processor. For example, the processor may be a central processing unit (central processing unit, CPU). Alternatively, the processor may be another general-purpose processor, a digital signal processor (digital signal processor, DSP), an application-specific integrated circuit (application specific integrated circuit, ASIC), a field-programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

The apparatus 1500 may further include one or more memories 1520. The memory 1520 stores a program, where the program may be executed by the processor 1510, to cause the processor 1510 to perform the methods described in the foregoing method embodiments. The memory 1520 may be separated from or integrated into the processor 1510.

The apparatus 1500 may further include a transceiver 1530. The processor 1510 may communicate with another device or chip through the transceiver 1530. For example, the processor 1510 may transmit data to and receive data from another device or chip by using the transceiver 1530.

An embodiment of the present application further provides a computer-readable storage medium for storing a program. The computer-readable storage medium may be applied to a first device or a second device provided in embodiments of the present application, and the program causes a computer to perform a method performed by the first device or the second device in various embodiments of the present application.

The computer-readable storage medium may be any available medium accessible by a computer or a data storage device such as a server or a data center that integrates one or more available media. The usable medium may be a magnetic medium (for example, a floppy disk, a hard disk, or a magnetic tape), an optical medium (for example, a digital video disc (digital video disc, DVD)), a semiconductor medium (for example, a solid-state drive (solid state disk, SSD)), or the like.

An embodiment of the present application further provides a computer program product. The computer program product includes a program. The computer program product may be applied to a first device or a second device provided in embodiments of the present application, and the program causes a computer to perform a method performed by the first device or the second device in various embodiments of the present application.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (digital subscriber line, DSL)) manner or a wireless (such as infrared, wireless, and microwave) manner.

An embodiment of the present application further provides a computer program. The computer program may be applied to a first device or a second device provided in embodiments of the present application, and the computer program causes a computer to perform a method performed by the first device or the second device in various embodiments of the present application.

The terms “system” and “network” in the present application may be used interchangeably. In addition, the terms used in the present application are merely used to explain the specific embodiments of the present application, and are not intended to limit the present application. It should be noted that the terms “first”, “second”, “third”, “fourth”, etc. in the specification, claims, and drawings of the present application are used to distinguish between different objects, rather than to describe a specific order. In addition, the terms “include” and “have” and any variations thereof are intended to cover a non-exclusive inclusion.

In embodiments of the present application, the “indication” mentioned may be a direct indication or an indirect indication, or indicate an association. For example, A indicates B, which may mean that A directly indicates B, for example, B can be obtained by means of A; or may mean that A indirectly indicates B, for example, A indicates C, and B can be obtained by means of C; or may mean that there is an association relationship between A and B.

In embodiments of the present application, the term “corresponding” may mean that there is a direct or indirect correspondence between two elements, or that there is an association between two elements, or that there is a relationship of “indicating” and “being indicated”, “configuring” and “being configured”, or the like.

In embodiments of the present application, “pre-defining” or “pre-configuring” can be implemented by pre-storing corresponding codes, tables, or other forms that may be used to indicate related information in devices (for example, including a terminal device and a network device). A specific implementation thereof is not limited in the present application. For example, being pre-defined may refer to being defined in a protocol.

In embodiments of the present application, the “protocol” may indicate a standard protocol in the communication field, which may include, for example, an LTE protocol, an NR protocol, and a related protocol applied to a future communication system. This is not limited in the present application.

In embodiments of the present application, determining B based on A does not mean determining B based on only A, but instead B may be determined based on A and/or other information.

In embodiments of the present application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of the present application, sequence numbers of the foregoing processes do not mean execution orders. The execution orders of the processes should be determined based on functions and internal logic of the processes, and should not be construed as any limitation on the implementation processes of embodiments of the present application.

In several embodiments provided in the present application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not executed. In addition, the mutual coupling or direct coupling or communication connection shown or discussed may be indirect coupling or communication connection through some interfaces, apparatuses, or units, and may be in electrical, mechanical, or other forms.

The units described as separate parts may be or may not be physically separate, and parts displayed as units may be or may not be physical units, and may be at one location, or may be distributed on a plurality of network elements. Some or all of the units may be selected according to actual needs to achieve the objective of the solutions of embodiments.

In addition, functional units in embodiments of the present application may be integrated into one processing unit, or each of the units may exist alone physically, or two or more units may be integrated into one unit.

The foregoing descriptions are merely specific implementations of the present application, but the scope of protection of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A method for wireless communication, comprising:
receiving, by a reduced capability (RedCap) user equipment (UE) operating in a non-terrestrial network (NTN), configuration information that indicates a plurality of priority orders respectively associated with a plurality of time-frequency resources for a half-duplex operation;
transmitting or receiving, by the RedCap UE, a first transmission on a first resource according to a first priority order,
wherein the first resource is one of the plurality of time-frequency resources, the first priority order is one of the plurality of priority orders, and the first priority order corresponds to the first resource.

2. The method according to claim 1, wherein the first transmission is one of a plurality of transmissions, the plurality of transmissions comprise a first category of transmission and a second category of transmission other than the first category of transmission, the first priority order comprises a priority of the first category of transmission being higher than a priority of the second category of transmission, and the first category of transmission comprises one or more of following:
a downlink transmission of a system information block (SIB);
at least one of a timing advance report (TAR) or a TAR-triggered scheduling request (SR);
a transmission with hybrid automatic repeat request (HARQ) feedback enabled or disabled; or
an uplink transmission based on demodulation reference signal (DMRS) bundling.

3. The method according to claim 2, wherein the first category of transmission further comprises a downlink transmission of a SIB19, and the first priority order comprises a priority of the downlink transmission of the SIB19 being higher than a priority of the transmission with HARQ feedback enabled or disabled, a priority of at least one of the TAR or the TAR-triggered SR, and a priority of the uplink transmission based on DMRS bundling.

4. The method according to claim 2, wherein the first priority order comprises a priority of the transmission with HARQ feedback enabled or disabled being higher than a priority of at least one of the TAR or the TAR-triggered SR and a priority of the uplink transmission based on DMRS bundling.

5. The method according to claim 2, wherein the first priority order comprises a priority of at least one of the TAR or the TAR-triggered SR being higher than a priority of the uplink transmission based on DMRS bundling.

6. The method according to claim 1, wherein the first resource is related to a first TAR sent by the RedCap UE, wherein the first TAR is triggered based on one or more of following information:
an indication sent by a higher layer to trigger a TAR;
a timing advance (TA) offset threshold configured by a higher layer;
an operation service time of the RedCap UE; or
a service type of the RedCap UE.

7. The method according to claim 1, wherein the first resource comprises a resource corresponding to a guard time, and when the guard time corresponds to a plurality of transmissions, the method further comprises:
determining, by the RedCap UE, the first transmission from the plurality of transmissions based on the first priority order,
wherein a transmission other than the first transmission among the plurality of transmissions are performed on a resource after the guard time.

8. The method according to claim 7, wherein the guard time is determined based on at least one of an elevation angle between the RedCap UE and a satellite in the NTN or a change value of the elevation angle within a first time period.

9. The method according to claim 8, wherein the change value of the elevation angle within the first time period belongs to a plurality of value ranges, the plurality of value ranges comprise a first value range and a second value range, the first value range corresponds to a first guard time, and the second value range corresponds to a second guard time, wherein when a lower limit value of the first value range is greater than or equal to an upper limit value of the second value range, a length of the first guard time is greater than a length of the second guard time.

10. The method according to claim 7, wherein a start time of the guard time is
$${T}_{TA}^{Report} - {Δ}_{TA} ,$$
and an end time of the guard time is
$${T}_{TA}^{Report} + {Δ}_{T A} , where {T}_{T A}^{Report}$$
represents a current TA value of the RedCap UE, and Δ_{TA} represents a difference between the current TA value and a previous TA value.

11. The method according to claim 1, wherein the plurality of time-frequency resources comprise a plurality of transmission windows for a SIB19, and the plurality of transmission windows comprise a first transmission window and a second transmission window, wherein a priority order corresponding to the first transmission window comprises a priority of a downlink transmission of the SIB19 being the highest, and a priority order corresponding to the second transmission window comprises a priority of a downlink transmission of the SIB19 being the lowest.

12. A method for wireless communication, comprising:
transmitting, to a reduced capability (RedCap) user equipment (UE) operating in a non-terrestrial network (NTN), configuration information that indicates a plurality of priority orders respectively associated with a plurality of time-frequency resources for a half-duplex operation;
receiving or transmitting, by a second device in the NTN, a first transmission on a first resource,
wherein the first resource is one of the plurality of time-frequency resources, the first transmission is determined according to a first priority order, the first priority order is one of the plurality of priority orders, and the first priority order corresponds to the first resource.

13. An apparatus, comprising:
at least one processor; and
one or more non-transitory computer-readable storage media coupled to the at least one processor and storing programming instructions for execution by the at least one processor, wherein the programming instructions, when executed, cause the apparatus to perform operations comprising:
receiving, when operating in a non-terrestrial network (NTN), configuration information that indicates a plurality of priority orders respectively associated with a plurality of time-frequency resources for a half-duplex operation;
transmitting or receiving a first transmission on a first resource according to a first priority order,
wherein the first resource is one of the plurality of time-frequency resources, the first priority order is one of the plurality of priority orders, and the first priority order corresponds to the first resource, and wherein the apparatus is a reduced capability (RedCap) user equipment (UE).

14. The apparatus according to claim 13, wherein the first transmission is one of a plurality of transmissions, the plurality of transmissions comprise a first category of transmission and a second category of transmission other than the first category of transmission, the first priority order comprises a priority of the first category of transmission being higher than a priority of the second category of transmission, and the first category of transmission comprises one or more of following:
a downlink transmission of a system information block (SIB);
at least one of a timing advance report (TAR) or a TAR-triggered scheduling request (SR);
a transmission with hybrid automatic repeat request (HARQ) feedback enabled or disabled; or
an uplink transmission based on demodulation reference signal (DMRS) bundling.

15. The apparatus according to claim 14, wherein the first category of transmission further comprises a downlink transmission of a SIB19, and the first priority order comprises a priority of the downlink transmission of the SIB19 being higher than a priority of the transmission with HARQ feedback enabled or disabled, a priority of at least one of the TAR or the TAR-triggered SR, and a priority of the uplink transmission based on DMRS bundling.

16. The apparatus according to claim 14, wherein the first priority order comprises a priority of the transmission with HARQ feedback enabled or disabled being higher than a priority of at least one of the TAR or the TAR-triggered SR and a priority of the uplink transmission based on DMRS bundling.

17. The apparatus according to claim 14, wherein the first priority order comprises a priority of at least one of the TAR or the TAR-triggered SR being higher than a priority of the uplink transmission based on DMRS bundling.

18. The apparatus according to claim 13, wherein the first resource is related to a first TAR sent by the apparatus, wherein the first TAR is triggered based on one or more of following information:
an indication sent by a higher layer to trigger a TAR;
a timing advance (TA) offset threshold configured by a higher layer;
an operation service time of the apparatus; or
a service type of the apparatus.

19. The apparatus according to claim 13, wherein the first resource comprises a resource corresponding to a guard time, and when the guard time corresponds to a plurality of transmissions, the operations further comprise:
determining the first transmission from the plurality of transmissions based on the first priority order,
wherein a transmission other than the first transmission among the plurality of transmissions are performed on a resource after the guard time.

20. The apparatus according to claim 19, wherein the guard time is determined based on at least one of an elevation angle between the apparatus and a satellite in the NTN or a change value of the elevation angle within a first time period.
